(19) United States
(12) Patent Application Publication
(10) Pub. No.: US 2013/0069633 A1
(43) Pub. Date: Mar. 21, 2013

(54) FAN SPEED DETECTION DEVICE

(71) Applicants: Yi-Xin TU, Shenzhen City (CN); Jin-Liang XIONG, Shenzhen City (CN); Hai-Qing ZHOU, Shenzhen City (CN)

(72) Inventors: Yi-Xin TU, Shenzhen City (CN); Jin-Liang XIONG, Shenzhen City (CN); Hai-Qing ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/427,914

(22) Filed: Mar. 23, 2012

(30) Foreign Application Priority Data
Sep. 20, 2011 (CN) 201110279590.2

(51) Int. Cl. G01P 3/48

(52) U.S. Cl. 324/163

(57) ABSTRACT

A fan speed detection circuit includes a counter, an integrating circuit, a current regulation circuit, a connector and a matching circuit. The connector electrically connects to the current regulation circuit and a fan. The counter outputs a pulse signal, the integrating circuit receives the pulse signal from the counter, and converts the pulse signal from the counter into a corresponding analog command signal. The current regulation circuit adjusts the current from the integrating circuit according to the command signal and outputs the adjusted current to the connector. The matching circuit converts the voltage from the connector and provides a suitable voltage for activating the counter to enable the counter to detect and quantify and record the rotation speed of the fan in all circumstances.

### BACKGROUND

1. Technical field

The disclosure generally relates to control circuits, and more particularly to a fan speed detection circuit for detecting rotational speed of fans.

2. Description of the Related Art

Computer cases and servers use fans for cooling purposes, so it is important to test the performance (e.g., rotational speed) of the fans. The rotational speed of the fan used in servers is generally controlled by adjusting the duty cycle of pulse width modulation (PWM) signals. However, when the duty cycle of the PWM signal is set low enough, a counter for calculating fan speed may not be activated by such a low duty cycle, so it fails to accurately detect the pulse signals from the fan, misleading users to think that the fan has in fact stopped.

Therefore, there is room for improvement within the art.

### BRIEF DESCRIPTION OF THE DRAWINGS

Many aspects of a fan speed detection device can be better understood with reference to the following drawings. The components in the drawings are not necessarily drawn to scale, the emphasis instead being placed upon clearly illustrating the principles of the fan speed detection device. Moreover, in the drawings, like reference numerals designate corresponding parts throughout the several views. Wherever possible, the same reference numbers are used throughout the drawings to refer to the same or like elements of an embodiment.

FIG. 1 is a block view of one embodiment of a fan speed detection circuit used for a fan of the disclosure.

FIG. 2 is a circuit view of the fan speed detection circuit shown in FIG. 1 of the disclosure.

### DETAILED DESCRIPTION

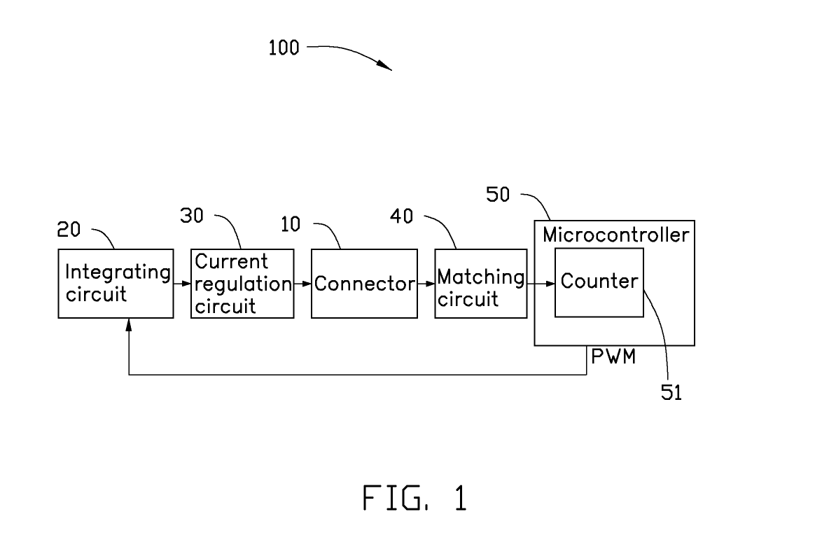

FIG. 1 is a block view of one embodiment of a fan speed detection circuit 100 used for a fan (not shown) of the disclosure. The fan speed detection circuit 100 is used to detect and quantify the rotational speed of the fan. In this embodiment, the fan can be a computer fan that is used for cooling purpose, and which draws cooler air into a computer from the outside, and/or expels warm air to the outside from the inside.

The detection circuit 100 includes a connector 10, an integrating circuit 20, a current regulation circuit 30, a matching circuit 40, and a microcontroller 50. The integrating circuit 20, the current regulation circuit 30, the connector 10, the matching circuit 40 and the microcontroller 50 are electrically connected in series. The integrating circuit 20 is electrically connected to the microcontroller 50, and can receive pulse width modulation (PWM) signals from the microcontroller 50.

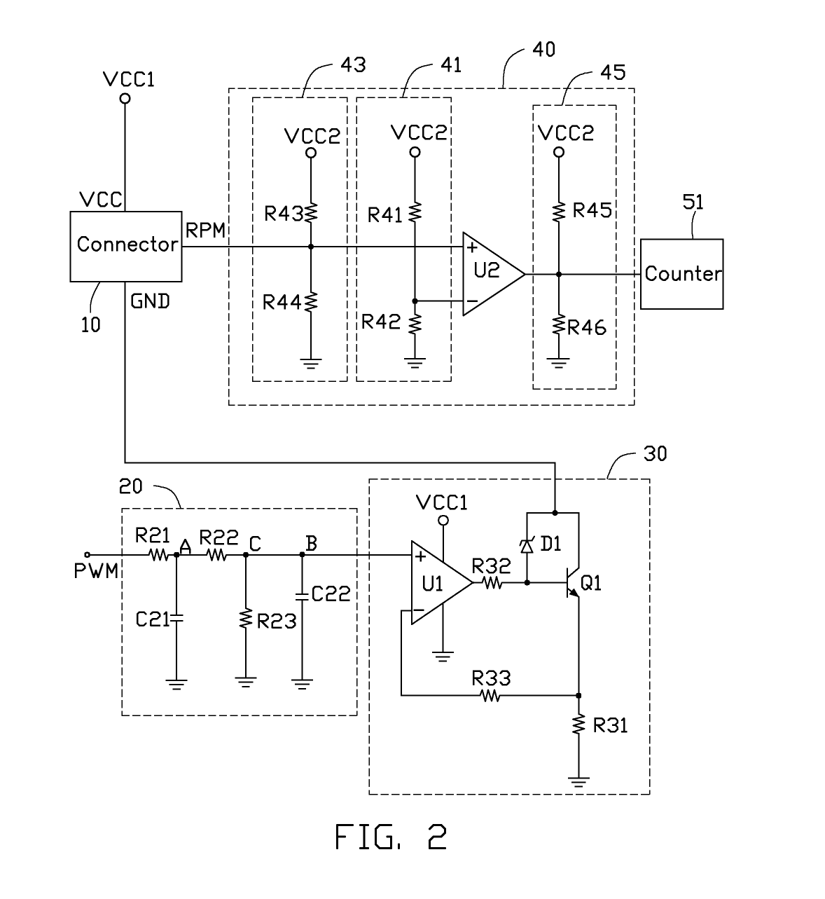

Referring to FIG. 2, the connector 10 is electrically connected to the fan, and includes a power pin VCC, a ground pin GND and a detection pin RPM. The power pin VCC is electrically connected to a first power source VCC1, and the ground pin GND is electrically connected to the current regulation circuit 30. The detection pin RPM is electrically connected to the matching circuit 40. When the fan has rotated a single complete revolution, the detection pin RPM then outputs a pulse signal to the matching circuit 40.

The integrating circuit 20 can provide an output signal that is the time integral of the input signal from the microcontroller 50. In this embodiment, the integrating circuit 20 is capable of converting the discrete PWM signal (i.e., the digital signal) from the microcontroller 50 into a corresponding continuous linear command signal (i.e., an analog signal). The integrating circuit 20 includes a first resistor R21, a second resistor R22, a first capacitor C21, and a second capacitor C22.

The first resistor R21 and the second resistor R22 are electrically connected between the microcontroller 50 and the current regulation circuit 30. The first capacitor C21 is electrically connected to ground and to a node A between the resistor R21 and the second resistor R22. Thus, the first resistor R21 and the first capacitor C21 form a first resistor-capacitor (RC) integrating circuit. The second capacitor C22 is electrically connected to ground and to a node B between the second resistor R22 and the current regulation circuit 30. Therefore, the second resistor R22 and the second capacitor C22 form a second RC integrating circuit. The first RC integrating circuit integrates the command signal from the microcontroller 50; the second RC integrating circuit can doubly integrate the integral of the command signal from the first RC integrating circuit.

The integrating circuit 20 further includes a first voltage dividing resistor R23 connected parallel to the second capacitor C22. The first voltage dividing resistor R23 is electrically connected to ground and to a node C between the node B and the second resistor R22. The voltage dividing resistor R23 can adjust the output voltage from the microcontroller 50 and provide the adjusted voltage for the current regulation circuit 30. Moreover, providing that the output voltage from the second RC integrating circuit substantially matches the operation voltage of the current regulation circuit 30, the first dividing resistor R23 can be omitted.

The current regulation circuit 30 can adjust the supply of current depending upon the changes of the command signal (i.e., the analog signal) from the integrating circuit 20, and output the adjusted current to the connector 10, thus to achieve a correspondence whereby the rotational speed of the fan can be adjusted. The current regulation circuit 30 includes a transistor Q1, an operational amplifier U1, a diode D1, and a current sensing resistor R31. In this embodiment, the transistor Q1 can be an npn transistor, and includes a base, a collector and an emitter. The collector of the transistor Q1 is electrically connected to the ground pin GND of the connector 10, the base of the transistor Q1 electrically connects to the output of the operational amplifier U1 through a current limiting resistor R32. The emitter of the transistor Q1 is electrically connected to ground through the current sensing resistor R31.

The non-inverting input of the operational amplifier U1 electrically connects to the node B and the node C, and the inverting input of the operational amplifier U1 is electrically connected between the emitter of the transistor Q1 and the current sensing resistor R31 through a feedback resistor R33. The positive power pin of the operational amplifier U1 is electrically connected to the power source VCC1 to provide additional power for amplification of the output signal, the negative power pin of the operational amplifier U1 is electrically connected to ground. The positive power pin and the negative power pin can be left out of the circuit view.

The diode D1 can be a zener diode which allows current to flow in one direction or in the reverse direction if a breakdown voltage level is applied. In this embodiment, the anode of the diode D is electrically connected between the current limiting resistor R32 and the base of the transistor Q1, and the cathode of the diode D is electrically connected to the collector of the transistor Q1 and the ground pin GND of the connector 10. When the output of the operational amplifier U1 outputs a suitable current to the base of the transistor Q1, the transistor Q1 is turned on. Thus, the power source VCC1, the connector 10, the transistor Q1 and the current sensing resistor R31 form a current path, and the power source VCC1 can power the fan.

When the duty cycle of the PWM signal increases, the input voltage of the non-inverting input of the operational amplifier U1 increases accordingly, and the current limiting resistor R32, the transistor Q1 and the feedback resistor R33 form a feedback circuit, which enables voltage of the inverting input to equate to the voltage of the non-inverting input of the operational amplifier U1. Thus, the amount of output current that flows through the connector 10 increases, and the rotational speed of the fan increases accordingly. When the duty cycle of the PWM signal is reduced, the input voltage of the non-inverting input of the operational amplifier U1 decreases, and the rotational speed of the fan accordingly reduces.

When the duty cycle of the PWM signal falls below a predetermined value, the voltage level of the power source VCC1 is above the breakdown voltage of the diode D1, and the current from the first power source VCC1 flows through the diode D1 along the reverse direction (i.e., from the cathode to anode of the diode DO to the base of the transistor Q1. Thus, the transistor Q1 is switched on, and the first power source VCC1, the connector 10, the diode D1, the transistor Q1 and the current sensing resistor R31 are electrically connected in series to ground, and form a current path.

The matching circuit 40 can convert the voltage from the connector 10 into a voltage matching with the connector 10 and the microcontroller 50. In this embodiment, the matching circuit 40 includes a comparator U2, a first voltage dividing circuit 41, a second voltage dividing circuit 43, and a third voltage dividing circuit 45. The comparator U2 includes a non-inverting input, an inverting input and an output. The first voltage dividing circuit 41 includes a second voltage dividing resistor R41 and a third voltage dividing resistor R42 which are electrically connected between a second power source VCC2 and ground, in series. The second voltage dividing circuit 43 includes a fourth voltage dividing resistor R43, and a fifth voltage dividing resistor R44, which are electrically connected between the power source VCC2 and ground, in series. The third voltage dividing circuit 45 includes a third resistor R45 and a fourth resistor R46 which are electrically connected between the power source VCC2 and ground in series.

The comparator U2 compares two voltages and switches its output to indicate which one is larger. The non-inverting input of the comparator U2 is electrically connected to the detection pin RPM of the connector 10 and is electrically connected between the voltage dividing resistors R43 and R44. The inverting input is electrically connected between the voltage dividing resistors R41 and R42 and obtains a reference voltage from the first voltage dividing circuit 41. The output of the comparator U2 is electrically connected to the microcontroller 50 and is electrically connected between the third resistor R45 and the fourth resistor R46. In other embodiment, the reference voltage can be provided for the inverting input by a power supply. The voltage of the second power source VCC2 can be 5V. The voltage of the first power source VCC1 is 12V.

The detection pin RPM of the connector 10 is electrically connected between the voltage dividing resistors R43 and R44, so the second voltage dividing circuit 43 can provide a matching voltage for the detection pin RPM and the non-inverting input. The microcontroller 50 is electrically connected between the resistors R45 and R46, so the third voltage dividing circuit 45 can provide a matching voltage for the outputs of the comparator U2 and the microcontroller 50. In other embodiments, the second voltage dividing circuit 43 and the third voltage dividing circuit 45 can be omitted.

The microcontroller 50 includes a counter 51 electrically connected to the output of the comparator U2 and to the resistors R45 and R46. The counter 51 can detect and quantify and record the rotational speed and the number of duty revolutions applied to the fan. In this embodiment, the microcontroller 50 can be a super input/output integrated circuit or a Southbridge chipset. When the fan rotates over a complete revolution, the detection pin RPM outputs a high-low level pulse signal to the counter 51, and the counter 51 starts counting.

In use, when the fan rotates over a complete revolution, the detection pin RPM outputs a high-low level pulse signal to the non-inverting input of the comparator U2. If the duty cycle of the PWM signal is greater than the predetermined value, the output voltage from the comparator U2 provides a suitable voltage for activating the counter 51. Thus, the counter 51 can accurately detect the pulse signal and count the pulse signals in the normal way. If the duty cycle of the PWM signal is less than the predetermined value, the voltage of the collector of the transistor Q1 goes down, and the detection pin RPM outputs a low level pulse signal (e.g., logical 0) to the non-inverting input of the comparator U2 which is below the reference voltage of the inverting input. Thus, the comparator U2 outputs a low level signal to the counter 51, allowing the counter 51 to continue counting.

In the fan speed detection circuit 100 of the present disclosure, the matching circuit 40 can provide matching voltages for the connector 10 and the counter 51 of the microcontroller 50. Thus, even though the connector 10 outputs a PWM signal with low duty cycle to the matching circuit 40, the matching circuit 40 can perform matching and provide a suitable voltage for activating the counter 51 according to the pulse signal for the connector 10 and the counter 51. Therefore, the counter 51 is activated in any event and can accurately detect the pulse signals from the connector 10 in real time, which makes detecting easy.

In the present specification and claims, the word “a” or “an” preceding an element does not exclude the presence of a plurality of such elements. Further, the word “comprising” does not exclude the presence of elements or steps other than those listed.

It is to be understood, however, that even though numerous characteristics and advantages of the exemplary disclosure have been set forth in the foregoing description, together with details of the structure and functions of the exemplary disclosure, the disclosure is illustrative only, and changes may be made in detail, especially in the matters of shape, size, and arrangement of parts within the principles of this exemplary disclosure to the full extent indicated by the broad general meaning of the terms in which the appended claims are expressed.

What is claimed is:

1. A fan speed detection circuit comprising:
a counter for outputting a pulse signal;
an integrating circuit electrically connected to the counter and receiving the pulse signal from the counter;
a current regulation circuit electrically connected to the integrating circuit;
a connector electrically connected to the current regulation circuit and a fan; and
a matching circuit electrically connected to the connector and the counter, wherein the integrating circuit converts the pulse signal from the counter into a corresponding command signal, the current regulation circuit adjusts the current from the integrating circuit according to the command signal and outputs the adjusted current to the connector, and the matching circuit converts the voltage from the connector and provides a suitable voltage for activating the counter.

2. The fan speed detection circuit as claimed in claim 1, wherein the connector comprises a power pin, a ground pin and a detection pin, the power pin is electrically connected to a first power source, and the ground pin is electrically connected to the current regulation circuit, the detection pin is electrically connected to the matching circuit, when the fan has rotated a single complete revolution, the detection pin outputs the pulse signal to the matching circuit.

3. The fan speed detection circuit as claimed in claim 2, wherein the integrating circuit comprises a first resistor, a second resistor, a first capacitor, and a second capacitor, the first resistor and the second resistor are electrically connected between the counter and the current regulation circuit, the first capacitor is electrically connected to ground and the first resistor and the second resistor, the second capacitor is electrically connected to ground and the second resistor and the current regulation circuit.

4. The fan speed detection circuit as claimed in claim 3, wherein the first resistor and the first capacitor form a first resistor-capacitor (RC) integrating circuit to integrate the command signal from the counter, the second resistor and the second capacitor from a second RC integrating circuit, the second RC integrating circuit can doubly integrate the integral of the command signal from the first RC integrating circuit.

5. The fan speed detection circuit as claimed in claim 2, wherein the current regulation circuit comprises a transistor, an operational amplifier, and a current sensing resistor, the transistor comprises a base, a collector and an emitter, the operational amplifier comprises a non-inverting input, an inverting input and an output, the collector of the transistor is electrically connected to the ground pin of the connector, the base of the transistor is electrically connected to the output of the operational amplifier through a current limiting resistor, the emitter of the transistor is electrically connected to ground through the current sensing resistor, the non-inverting input of the operational amplifier is electrically connected to the second capacitor, the second resistor and the first voltage dividing resistor, the inverting input of the operational amplifier is electrically connected between the emitter of the transistor and the current sensing resistor through a feedback resistor.

6. The fan speed detection circuit as claimed in claim 5, wherein the current regulation circuit further comprises a diode, the anode of the diode is electrically connected between the current limiting resistor and the base of the transistor, and the cathode of the diode is electrically connected to the collector of the transistor and the ground pin of the connector, when the output of the operational amplifier outputs a suitable current to the base of the transistor, the transistor is turned on, the power source, the connector, the transistor and the current sensing resistor then form a current path, and the power source powers the fan.

7. The fan speed detection circuit as claimed in claim 6, wherein the transistor is an npn transistor, the diode is a zener diode which allows current to flow in forward direction or in the reverse direction.

8. The fan speed detection circuit as claimed in claim 2, wherein the matching circuit comprises a first voltage dividing circuit, a second voltage dividing circuit, and a third voltage dividing circuit, the first voltage dividing circuit comprises a second voltage dividing resistor and a third voltage dividing resistor which are electrically connected between a second power source and ground in series, the second voltage dividing circuit comprises a fourth voltage dividing resistor and a fifth voltage dividing resistor which are electrically connected between the second power source and ground in series, and the third voltage dividing circuit comprises a third resistor and a fourth resistor which are electrically connected between the second power source and ground in series.

9. The fan speed detection circuit as claimed in claim 8, wherein the matching circuit further comprises a comparator, the comparator comprises an inverting input, a non-inverting input and an output, the non-inverting input of the comparator is electrically connected to the detection pin of the connector and is electrically connected between the fourth voltage dividing resistor and the fifth voltage dividing resistor, the inverting input of the comparator is electrically connected between the second voltage dividing resistor and the third voltage dividing resistor to obtain a reference voltage from the first voltage dividing circuit, the output of the comparator is electrically connected to the counter and is electrically connected between the third resistor and the fourth resistor.

10. The fan speed detection circuit as claimed in claim 9, wherein the counter is electrically connected to the output of the comparator and the third resistor and the fourth resistor, the counter detects and records the rotational speed and the number of revolutions applied to the fan, when the fan rotates over a complete revolution, the detection pin outputs a pulse signal to the counter, and the counter starts counting.

11. A fan speed detection circuit used to detect and quantify rotational speed of a fan to test the performance of the fan, the fan speed detection circuit comprising:
a microcontroller for providing a pulse signal, the microcontroller comprising:
a counter for detecting and recording the rotational speed and the number of revolutions applied to the fan;
an integrating circuit electrically connected to the counter and converting the pulse signal from the counter into a corresponding analog signal;
a current regulation circuit electrically connected to the integrating circuit, and adjusting output current from the integrating circuit according to the analog signal;
a connector electrically connected to the current regulation circuit and the fan; and
a matching circuit electrically connected to the connector and the counter, wherein the current regulation circuit outputs the adjusted current to the connector to control the rotational speed of the fan, and the matching circuit converts output voltage from the connector into a suitable voltage for activating the counter and provides the voltage to match the voltage with the counter.

12. The fan speed detection circuit as claimed in claim 11, wherein the connector comprises a power pin, a ground pin and a detection pin, the power pin is electrically connected to a first power source, and the ground pin is electrically connected to the current regulation circuit, the detection pin is electrically connected to the matching circuit, when the fan has rotated a single complete revolution, the detection pin outputs the pulse signal to the matching circuit.

13. The fan speed detection circuit as claimed in claim 12, wherein the integrating circuit comprises a first resistor, a second resistor, a first capacitor, and a second capacitor, the first resistor and the second resistor are electrically connected between the counter and the current regulation circuit, the first capacitor is electrically connected to ground and the first resistor and the second resistor, the second capacitor is electrically connected to ground and the second resistor and the current regulation circuit.

14. The fan speed detection circuit as claimed in claim 13, wherein the first resistor and the first capacitor form a first resistor-capacitor (RC) integrating circuit to integrate the command signal from the counter, the second resistor and the second capacitor from a second RC integrating circuit, the second RC integrating circuit can doubly integrate the integral of the command signal from the first RC integrating circuit.

15. The fan speed detection circuit as claimed in claim 12, wherein the current regulation circuit comprises a transistor, an operational amplifier, and a current sensing resistor, the transistor comprises a base, a collector and an emitter, the operational amplifier comprises a non-inverting input, an inverting input and an output, the collector of the transistor is electrically connected to the ground pin of the connector, the base of the transistor is electrically connected to the output of the operational amplifier through a current limiting resistor, the emitter of the transistor is electrically connected to ground through the current sensing resistor, the non-inverting input of the operational amplifier is electrically connected to the second capacitor, the second resistor and the first voltage dividing resistor, the inverting input of the operational amplifier is electrically connected between the emitter of the transistor and the current sensing resistor through a feedback resistor.

16. The fan speed detection circuit as claimed in claim 15, wherein the current regulation circuit further comprises a diode, the anode of the diode is electrically connected between the current limiting resistor and the base of the transistor, and the cathode of the diode is electrically connected to the collector of the transistor and the ground pin of the connector, when the output of the operational amplifier outputs a suitable current to the base of the transistor, the transistor is turned on, the power source, the connector, the transistor and the current sensing resistor then form a current path, and the power source powers the fan.

17. The fan speed detection circuit as claimed in claim 16, wherein the transistor is an npn transistor, the diode is a zener diode which allows current to flow in forward direction or in the reverse direction.

18. The fan speed detection circuit as claimed in claim 12, wherein the matching circuit comprises a first voltage dividing circuit, a second voltage dividing circuit, and a third voltage dividing circuit, the first voltage dividing circuit comprises a second voltage dividing resistor and a third voltage dividing resistor which are electrically connected between a second power source and ground in series, the second voltage dividing circuit comprises a fourth voltage dividing resistor and a fifth voltage dividing resistor which are electrically connected between the second power source and ground in series, and the third voltage dividing circuit comprises a third resistor and a fourth resistor which are electrically connected between the second power source and ground in series.

19. The fan speed detection circuit as claimed in claim 18, wherein the matching circuit further comprises a comparator, the comparator comprises an inverting input, a non-inverting input and an output, the non-inverting input of the comparator is electrically connected to the detection pin of the connector and is electrically connected between the fourth voltage dividing resistor and the fifth voltage dividing resistor, the inverting input of the comparator is electrically connected between the second voltage dividing resistor and the third voltage dividing resistor to obtain a reference voltage from the first voltage dividing circuit, the output of the comparator is electrically connected to the counter and is electrically connected between the third resistor and the fourth resistor.

20. The fan speed detection circuit as claimed in claim 19, wherein the counter is electrically connected to the output of the comparator and the third resistor and the fourth resistor, the counter detects and records the rotational speed and the number of revolutions applied to the fan, when the fan rotates over a complete revolution, the detection pin outputs a pulse signal to the counter, and the counter starts counting.
